(19) United States
(12) Patent Application Publication
(10) Pub. No.: US 2009/0140117 A1
(43) Pub. Date: Jun. 4, 2009

(54) Turret mount system and method

(76) Inventor: Rodney Nairne, Jupiter, FL (US)

Correspondence Address: Law office of Robert L. Powley, 304 Hudson Street, 2nd Floor, New York, NY, 10013, US

(21) Appl. No.: 11/629,315

(22) PCT Filed: Jun. 15, 2005
(86) PCT No.: PCT/US05/21010

§ 371 Date: Dec. 12, 2006

Related U.S. Application Data
(60) Provisional application No. 60/580,170, filed on Jun. 15, 2004.

(51) Int. Cl. F16M 13/02; B63C 11/46

(52) U.S. Cl. 248/349.1; 114/315

(57) ABSTRACT

A turret mount apparatus that allows for an instrument to be rotatably and removably attached to a vehicle platform, such as an underwater scooter. In an underwater scooter implementation, such an apparatus comprises two primary components: one attached to the scooter, namely, a turret mount base, the other directly or indirectly attachable to the instrument (e.g., camera), namely, a turret mount top, these two complementary components forming a turret and allowing rotational movement in the horizontal plane when mated. The turret mount apparatus allows a diver to attach and detach the turret mount, as well as rotate the instrument to the desired angle, manually without tools.

This application claims the benefit of U.S. Provisional Application No. 60/580,170, filed Jun 15, 2004.

### FIELD OF THE INVENTION

This invention relates generally to mounting systems and methods, and more specifically, to a system and method for mounting equipment or instruments, such as a camera, onto a vehicle platform, such as an underwater diver propulsion vehicle (DPV).

### BACKGROUND INFORMATION

When taking underwater video, several camera angles can be easily taken which would be far more difficult on land. For example, you can hover easily 30 feet off the bottom taking an “aerial” view, giving the sensation of flying over the object.

However, there are many cases where taking underwater video is far more challenging than on land. Visibility can be very limited, so to take a video image of a shipwreck for example, it is impossible to do it in 1 continuous shot as the wreck could be 600 feet long and the visibility only 20 feet. In this case, it would be necessary to move the camera along all 600 feet of the wreck, not just take a shot from one position as would be possible on land.

Taking footage of a water filled cave passage, which might be up to 3 miles long, presents the challenge of both transporting the camera through the water and also taking footage while moving through the passage.

In both instances, due to the slow speed of the human swimmer and the drag created by video equipment, often a battery powered electric underwater scooter (a DPV) is used to transport the diver and the camera to the location.

In the past, many divers have attached the video camera directly to the scooter. This enables the diver to transport the camera to the site, whilst also allowing footage to be taken while moving forward towards or along the object, or through the passage. It can also be helpful when taking stationary shots as the mass of the scooter stabilizes the camera.

When operating the scooter with the video camera attached, it is most common to have the camera fixed in the look-ahead position. This, however, limits the footage to that angle. Many camera operators would like to be able to, e.g., take video with the camera pointed at different angles during a dive, not just at one angle. For example, in taking the footage of the wreck, in the look-ahead position the ship wreck will fill at most one half of the screen.

Sometimes divers themselves are the subject of the footage. If the divers are scootering, side by side, having the camera pointed directly ahead limits the shot to the rear of the filmed diver only—i.e., the diver directly in front of the camera; whereas the best shots may be looking back towards another scooter diver, or taking a shot from the side, all whilst moving forward. To take these other shots the camera would need to be attached to the scooter and pointed between 30 to 180 degrees from the direction of travel.

Another technical problem with underwater filming is “backscatter”. The water is almost never perfectly clear, and when you shine a light it illuminates the particles in the water, creating back scatter. For video, this results in poor footage.

A technical solution to the back scatter problem is to have the lights shine from a different angle than that of the camera. In this regard, the best solution for taking video with the scooter is to mount the lights on a 2nd scooter, and have that scooter shine the lights at the subject from a different angle.

Therefore, in view of the background information presented hereinabove, the need is manifest for advances in mounting systems for scooters, such as an improved camera mounting system that permits the camera to be pointed at different angles, which system could also be used for other equipment such as the video lights during filming; as they too may need to be rotated in the direction of the filming, and which system may be particularly used for mounting instruments, equipment, devices to an underwater scooter.

### SUMMARY OF THE INVENTION

The present invention provide such advancements and overcomes the above mentioned problems and other limitations of the background and prior art by providing a turret mount apparatus that allows for an instrument to be rotatably and removably attached to a vehicle platform, such as an underwater scooter.

In accordance with an aspect of the present invention, an apparatus comprises a base mount, an instrument mount, and at least one fastening mechanism. The base mount is configured to be fixed relative to a vehicle platform. The instrument mount is attachable to an instrument, and is configured to removably mount onto the base mount. The instrument mount is capable of being rotated about an axis of rotation when mounted to the base mount. The at least one fastening mechanism provides selective engagement of the instrument mount and the base mount.

In accordance with a further aspect of the present invention, the instrument mount and the base mount are configured to provide a direct coupling therebetween for mounting the instrument mount to the base mount, wherein the rotation of the instrument mount is provided by the direct coupling of the instrument mount and the base mount when the instrument mount is removably mounted to the base mount.

The direct coupling may be provided between (i) a disc-shaped plate having a cylindrical outer sidewall surface that has a circumferential groove; and (ii) a mating structure having a cylindrical inner sidewall surface that is disposed near, and coaxial with, said cylindrical outer sidewall surface when said instrument mount is removably mounted to the base mount. The mating structure further comprises at least one through-bore that traverses the cylindrical inner sidewall surface, and in which is provided at least one respective fastener that is movable to selectively engage the circumferential groove in the disc-shaped plate. In one implementation, the base mount comprises the disc-shaped plate, and the instrument mount comprises the mating structure.

In accordance with yet another aspect of the present invention, a turret mount apparatus is provided for mounting an instrument to an underwater scooter. An implementation of such an apparatus comprises two primary components: one attached to the scooter, namely, a turret mount base, the other attached to the instrument (e.g., camera), namely, a turret mount top, these two complementary components forming a turret and allowing rotational movement in the horizontal plane when mated. In accordance with a further aspect of the present invention, if the instrument cannot be attached directly to the turret mount top, or if otherwise desired or advantageous, an adapter plate may be used to allow customization for each application. The adaptor plate is configured to be affixed to the turret mount top, and will have mounting features customized to the instrument housing that is to be mounted thereto

As indicated, an aspect of the present invention, and an application for which the present invention is well suited and in which many distinct advantages of the present invention are manifest, is mounting an instrument such as a (e.g., video) camera to a diver operated underwater vehicle such as a diver propulsion vehicle (“DPV”) or scooter via a mounting system which allows the camera to be securably rotated to different positions and easily removed from the system, and particularly, where the turret mount allows a diver to attach and detach the turret mount, as well as rotate the instrument to the desired angle, manually without tools. A further aspect relates to attaching the turret mount apparatus to a cylindrical underwater scooter/DPV hull, which may be implemented with a modified V-block.

Still another aspect of the present invention includes the provision of a locking mechanism to secure the instrument in any given axial position, such locking mechanism being, for example, a locking set screw. A system according to the present invention can further include the provision of detents to lock the instrument into preset, specific angles. The detents can, for example, be pre-machined slots or holes into which spring loaded detent pins, (e.g., ball plungers or other mechanism) will hold the instrument in the desired pan angle, (this feature is sometimes also called indexing).

In accordance with another aspect of the present invention, the instrument mount will be easily detachable from the turret base underwater without tools. As may be appreciated, this allows for remote operation of instruments separate from the underwater vehicle. This ease and speed of detachment will also allow the instrument (e.g., camera or other device) to be separated from the scooter before it is loaded into or out of the water, thereby protecting the instrument from extra risk of damage, during deployment or retrieval of the DPV scooter.

It will be appreciated by those skilled in the art that the foregoing brief description and the following detailed description are exemplary and explanatory of this invention, but are not intended to be restrictive thereof or limiting of the advantages which can be achieved by this invention. Thus, the accompanying drawings, referred to herein and constituting a part hereof, illustrate preferred embodiments of this invention, and, together with the detailed description, serve to explain the principles of this invention.

### BRIEF DESCRIPTION OF THE DRAWINGS

Additional aspects, features, and advantages of the invention, both as to its structure and operation, will be understood and will become more readily apparent when the invention is considered in the light of the following description made in conjunction with the accompanying drawings, wherein:

FIGS. 1-4 illustrate isometric views of a an illustrative embodiment of a turret mount apparatus according to the present invention.

FIG. 5 depicts an embodiment of a turret base mount having aligned slots for fixably attaching the turret mount base.

FIGS. 6 A and B illustrate the use of an adaptor plate for attaching an instrument housing to turret mount apparatus and a nose portion turret mount base, according to alternative embodiments of the present invention.

FIGS. 7 A and B illustrate a side view and a front view, respectively, of an embodiment of the present invention where a sealable chamber mounted to adaptor plate via U-clamps.

FIG. 8 depicts a cross-section taken from the vantage point identified by reference label VIII in FIG. 7A.

FIG. 9 illustrates a cross-section corresponding to the cross-section of FIG. 8, but with turret mount top spaced away from (elevated above) turret mount base for purposes of illustration.

FIG. 10 depicts a cross-section taken from the vantage point identified by reference label X in FIG. 8.

FIGS. 11A and B depicts a bottom and top view, respectively, from the vantage point identified by reference label XI in FIG. 10

FIG. 12 illustrates a top view, looking down onto hull, adaptor plate, and sealable housing, for two different azimuthal angles of the turret mount apparatus.

### DETAILED DESCRIPTION OF EMBODIMENTS OF THE INVENTION

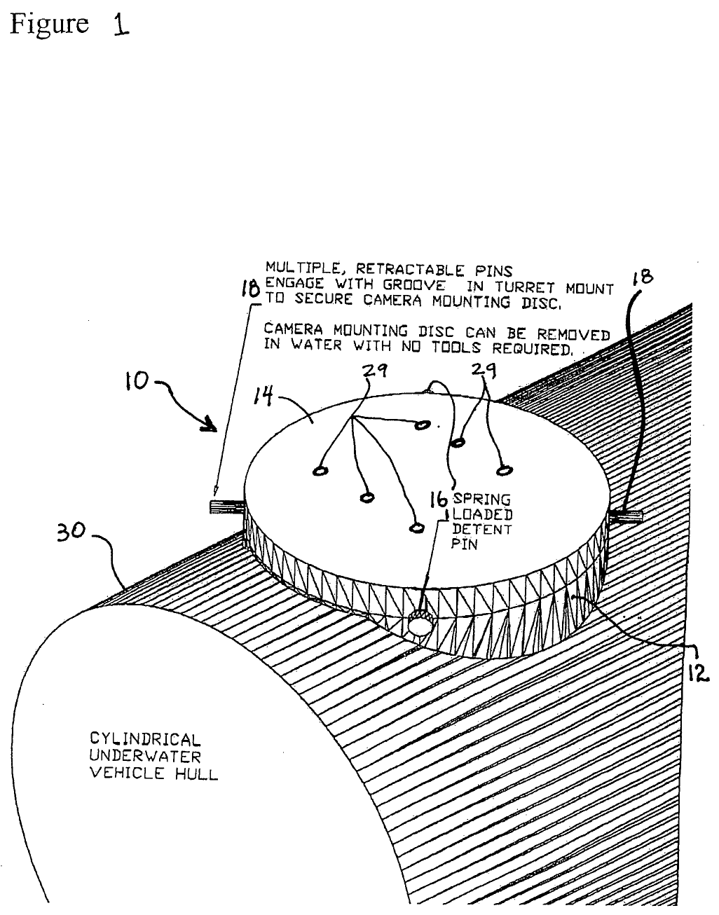

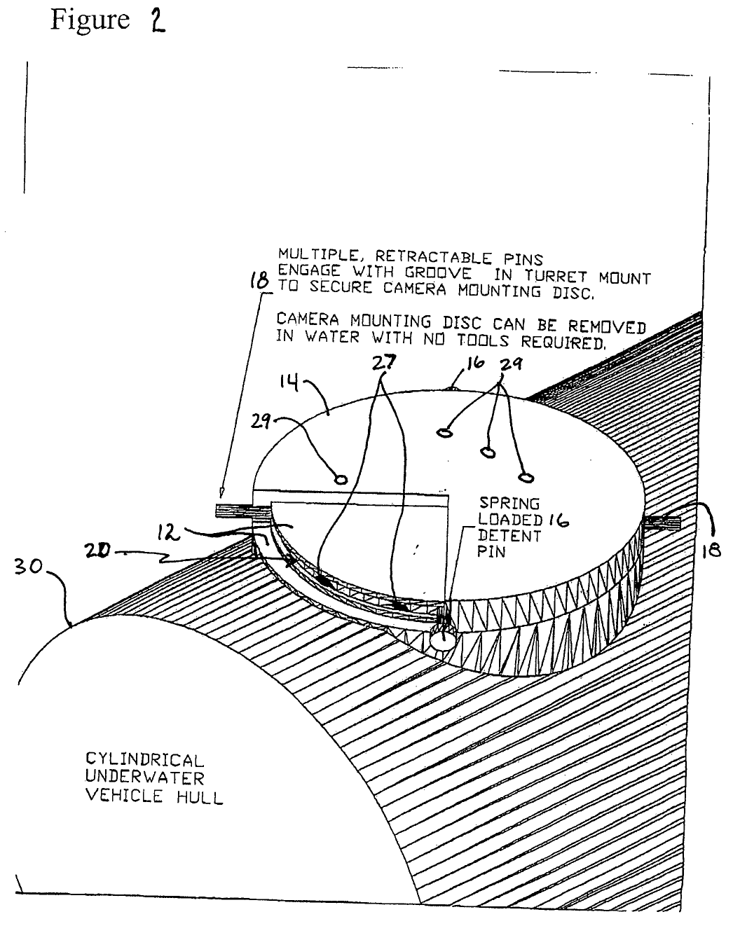

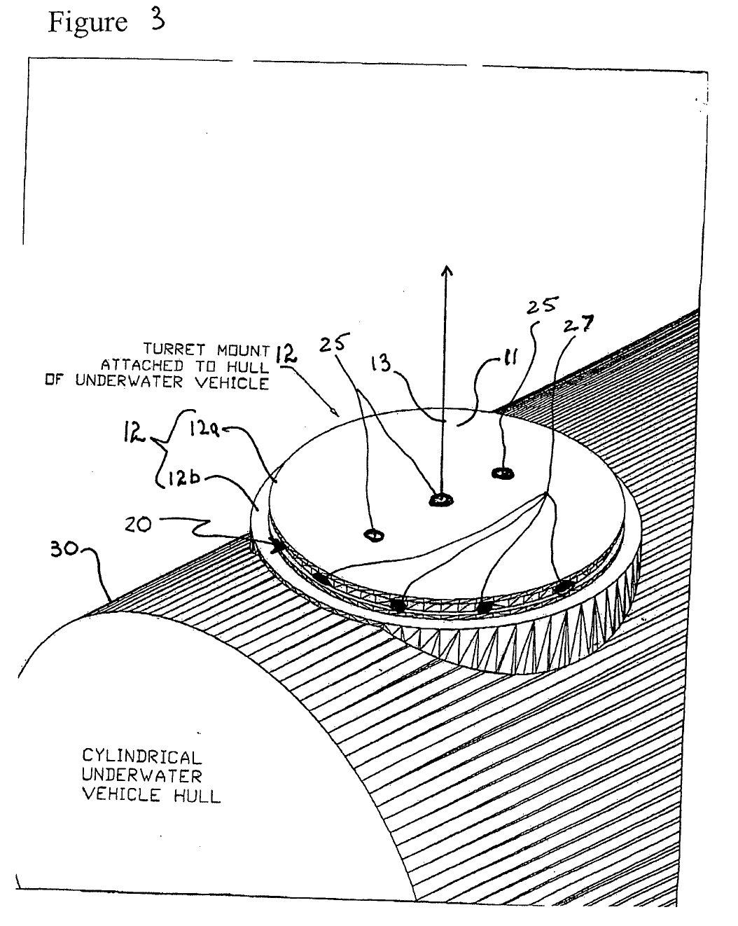

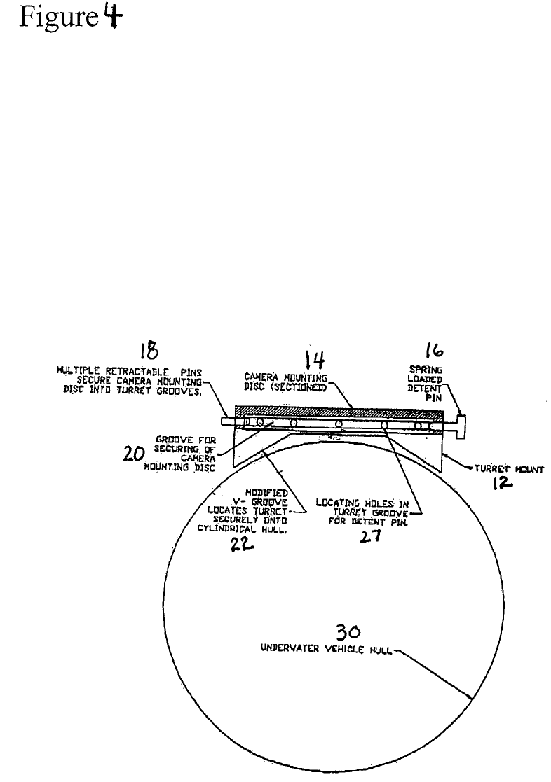

In accordance with an illustrative embodiment of the present invention, FIGS. 1-3 depict isometric views of a turret mount apparatus 10 that includes a turret mount base 12, turret mount top 14, spring loaded detent pins 16, and retractable pins 18. More specifically, FIG. 2 and FIG. 3 are isometric views corresponding to FIG. 1, except that in FIG. 2 and FIG. 3 turret mount top 14 is sectioned (i.e., partially removed or cut away) and entirely removed, respectively, so as to reveal additional structural detail of turret mount base 12 and turret mount top 14 and how these components are physically coupled to each other, as further described below. In these figures, turret mount apparatus 10 is shown together with an underwater vehicle (e.g., DPV) hull 30, which typically has a cylindrical shape as shown (e.g., a hull with a 10.75 inch outer diameter).

For ease of reference and clarity of exposition, a first set of cylindrical coordinates is referenced with respect to the top surface 11 of turret base mount 12, and a second set of cylindrical coordinates is referenced with respect to the cylindrically shaped hull 30. More specifically, as used herein, a turret axis of rotation 13 is defined as an axis perpendicular to, and passing through the center of, circular upper surface 11 of turret base mount 12, as shown in FIG. 3. The hull axis (not shown) refers to the cylindrical axis of the cylindrically shaped hull.

Turret mount base 12 is fixed relative to hull 30, and complementary turret mount top 14 mates with turret mount base 12 to allow rotational movement of turret mount top 14 azimuthally around the turret axis. As described further below, turret mount top 14 is directly or indirectly (e.g., via an adaptor plate/member) attached to an instrument, equipment, tool, component, device etc. such as a video camera or other recording instrument, sonar or any type of scientific equipment, etc. (any such attachment referred to herein as an “instrument”), and thus turret mount apparatus 10 allows for complete rotational movement/orientation of an instrument attached thereto. Turret mount base 12 and top 14 may be made from hard coated, dichromate sealed aluminum, or any of a variety of other materials (e.g., Delrins™, metals, composites, plastics, etc.).

Referring to FIGS. 1-3 in more detail, turret mount base 12 may be integrally formed with hull 30 (e.g., a machined or molded hull including the turret mount base) or, alternatively, may be removably fixable (attachable/detachable) to hull 30 so that turret mount apparatus 10 may be provided as an add-on or attachment for existing underwater scooters. As shown in FIG. 3, turret mount base 12 includes a lower base portion 12b and an upper disc-like portion 12a, which in this embodiment are integrally formed, such as from a single block of metal (e.g., aluminum).

In an embodiment in which turret mount base 12 is removably fixable to hull 30, lower base portion 12b is advantageously configured to have a surface that securely mates with the cylindrically shaped hull 30. Securely attaching to a cylindrical surface is always intrinsically difficult compared to a flat surface. In one implementation, the hull mating surface of lower base portion 12b may have substantially the same cylindrical surface as the outer surface of the hull. Alternatively, in accordance with an embodiment of the present invention, the hull mating surface of lower base portion 12b is implemented as a modified V-block. V-block is a method commonly used to secure round work pieces to machine tools, and works by a clamping force on one side of a cylindrical object forcing the cylindrical object against the 2 sides of a V, hence providing a 3 point securing of the object. In this case of a modified V-block (also referred to herein as modified V-groove), the V shape is modified such that a flat section is provided between the two sides of the V, thus allowing the turret mount base 12 to have a very low profile. This modified V-groove 22 design is shown in FIG. 4, which depicts a cross-section of a turret mount apparatus 10 as in FIGS. 1-3, but spaced away from hull 30.

Using the modified V-groove, the turret mount base 12 may be secured to the hull with any of many methods including but not limited to the following: (1) nylon webbing with a quick acting cam-buckle, as commonly used to hold SCUBA tanks to divers harness (this method is described further below); (2) steel hose clamps; (3) mechanical fixtures such as bolts, channel, studs and clamps; and (4) plastic or metal welding. It is understood, however, that such securing methods may be used even if turret mount base 12 does not have a modified V-groove design.

For underwater scooters/DPV's which are not cylindrical, or which have some other portion which is not cylindrical, or which have some shape for which the V design may not provide the desired results, alternative designs/shapes of lower base portion 12b and/or alternative securing methods may be implemented for attaching turret mount base 12 to the scooter/DPV so that a turret mounting system according to the present invention may be used, as will be understood in view of the teachings of the present invention. That is, those skilled in the art will understand that the present invention is not limited to attachment to cylindrically shaped hulls, but may be implemented in accordance with any hull shape.

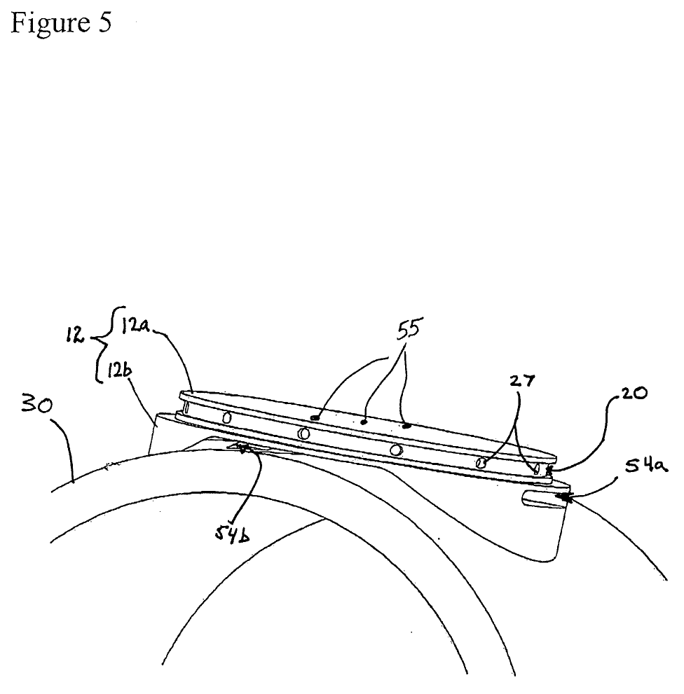

As noted above, turret mount base 12 may be removably attachable to a scooter by any of a variety of fastening mechanisms, such as straps, bolts, clamps, etc. FIG. 5 depicts an embodiment of a turret mount base 12 having aligned slots 54a and 54b through the sides of the V-groove, allowing for the turret mount base 12 to be fixably attached to scooter hull 30 by using, for example, a cam strap or hose clamp (not shown) which may be inserted through slots 54a and 54b and around the outer cylindrical surface of hull 30. Also shown are several bores 55 (which may be threaded and/or countersunk), which may be used in addition to, or instead of, slots 54a and 54b for attaching turret mount base 12 to scooter hull 30.

Referring again to FIGS. 1-3, upper portion 12a of turret mount base 12 is a disc-shaped (low profile cylindrically shaped) member having a slot 20, recess, or groove about the circumferential edge (outer cylindrical surface). A plurality of radially directed bores/holes 27 may be formed (e.g., drilled) into the slot 20, azimuthally distributed (e.g., every 30 degrees) about the turret axis.

It is noted that although in the foregoing embodiment lower base portion 12b and upper disc-like portion 12a are integrally formed, in an alternative implementation lower base portion 12b and upper disc-like portion 12a may be constructed as two separate parts that may be fixed relative to each other (e.g., by bolting to each other, or by bolts that pass through both elements and secure to the hull, by means of pins/bores, tabs/slots, etc.). Such two-part (modular) construction allows for the turret mount apparatus to be more readily adaptable for attachment to a variety of hull shapes or sizes (e.g., different outer diameters), as hull-specific, different sized/shaped lower base portion 12b may be made without having to also form (e.g., machine) upper disc-like portion 12a. That is, the same upper disc-like portion 12a may be attached to any hull-specific lower base portion 12b.

As shown in FIGS. 1-4, turret mount top 14 is generally a cylindrically shaped member having an upper disc-shaped surface, and a cylindrical sidewall that complements the outer circumferential edge of upper portion 12a of turret mount base 12. Bores/holes 29 (threaded and/or unthreaded) passing partially or entirely through turret mount top 14 may be formed for use in attaching turret mount top 14 directly or indirectly (e.g., via an adaptor plate, not shown in FIGS. 1-4) to an instrument. In accordance with the illustrated embodiment, retractable pins 18 and spring loaded detent pins 16 may be mounted into bores (e.g., threaded) formed at 90 degree intervals in the cylindrical sidewall of turret mount top 14. In FIGS. 1-3, the two retractable pins 18 are opposite each other (i.e., 180 degrees), as are the two spring loaded detent pins 16. For purposes of illustration, however, FIG. 4 shows a retractable pin 18 opposite a spring loaded detent pin 16, which is a possible arrangement, though not consistent with the implementation shown in FIGS. 1-3. As will be further understood below, alternative fasteners and/or mechanical guide mechanisms may be used instead of spring loaded detent pins or retractable pins (e.g. thumb screws/bolts may be used for retractable pins).

As shown in FIG. 4, the facing planar surfaces of turret mount top 14 and turret mount base 12 are spaced away from each other, reducing overall friction as well as the likelihood of debris (e.g., sand) impeding rotational motion. Additionally, this space allows some tolerance for mounting or fastening mechanisms used to attach turret mount top 14 to an instrument or adaptor plate (e.g., by means of holes/bores 29, shown in FIGS. 1 and 2), which mounting or fastening mechanisms may protrude into the space between facing planar surfaces of turret mount top 14 and turret mount base 12.

Analogous to the hereinabove description of the possible integral or two piece construction of turret mount base 12, it may be understood that the body of turret mount top 14 may also be implemented as a unitary element or, for instance, as a two piece construction. In an implementation of a two-component assembly, one component may be a top plate corresponding to the disc-shaped top portion (i.e., in which bores 29, shown in FIG. 1, are formed), with the other component corresponding to the cylindrical sidewall portion (i.e., in which the pins are disposed; this other component thus being in the form of a collar or ring-like structure). In such an implementation, the periphery (at 45 degree intervals) of the top plate may include through-holes/bores (e.g., countersunk) through the top (i.e., parallel to the turret axis), and the cylindrical sidewall portion (e.g., collar) may include corresponding threaded bores (i.e., parallel to the turret axis) such that the top plate may be attached to the cylindrical sidewall portion by placing the top plate onto the cylindrical sidewall portion (with the holes aligned) and inserting screws/bolts into the aligned holes. Such two-part (modular) construction of the turret mount top 14 allows for the turret mount apparatus to be more readily adaptable for direct attachment to a variety of instruments, as a top plate may be formed (e.g., machined) to have the appropriate array of through holes, or any other fastening mechanism, required for direct attachment to a given instrument, and the same cylindrical sidewall portion may be used. This approach, in many applications, may eliminate the need for a separate adaptor plate, as the top plate itself functions as an adaptor plate that may be directly attached to an instrument.

As will be understood, the hereinabove described illustrative turret mount apparatus 10 allows for removably securing the turret mount top 14 (and thus the instrument attached thereto) to the turret mount base (and thus to the scooter), allowing for 360 degree rotation of the turret mount top 14, and for securing the turret mount top 14 at indexed angles and/or at all possible angles, with all attaching, rotating, securing, and detaching operations capable of being performed manually by one individual, in water, with no requirement for tools. More specifically, in accordance with the above-described illustrative embodiment of a turret mount apparatus 10, with turret mount base 12 mounted to hull 30, and an instrument attached to turret mount top 14, the turret mount top 14 may be attached to the turret mount base 14 and the azimuthal orientation of the turret mount top 14 (and hence the attached instrument) about the turret axis may be set as follows.

Retractable pins 18 are placed in a retracted and locked position. In an implementation where thumb screws are used instead of, or in addition to, the retractable pins, such thumb screws are unscrewed to be in a retracted position. The instrument (e.g., camera housing) and/or turret mount top 12 is held, and the two spring plungers (i.e., spring loaded detent pins 16) are pulled out from either side of turret mount top 12. The turret mount top 14 is then engaged onto the turret mount base 12, and the spring plungers released, causing them to mechanically engage groove 20 in the turret mount base 12, thus securing the turret mount top 14 (and thus the instrument) to the scooter. If upon such engagement, the instrument is not positioned as desired, the instrument (and turret mount top) may be rotated about the turret axis to the desired position. Then, if required and/or desired, retractable pins can be inserted and/or thumb screws tightened to provide the friction necessary to hold the camera housing at the desired angle and/or to add further stability to the attachment. Such additional friction/stability may be particularly needed for angles other than those with preset positions in which an indexing hole/bore may be engaged.

It may be understood that for certain positions, indexing bores/holes 27 may be engaged by spring plungers (i.e., spring loaded detent pins 16) and/or retractable pins 18 (or, if used, thumb screws), mechanically locking the turret mount top 14 to the turret mount base, and thus locking the instrument at one of the indexed azimuthal angles. Alternatively, or in addition, a separate indexing spring plunger may be used to engage the indexing bores/holes 27.

In one embodiment, the spring plungers may be implemented such that upon release they engage the groove but are not capable of extending into indexing bores/holes 27. Accordingly, even after releasing the spring plungers, the individual can freely rotate the turret mount top 14 through all angles without having to pull on the spring plungers to avoid their engagement of the indexing bores/holes 27. In an alternative implementation, however, the spring plungers may be implemented such that upon release they can engage the indexing bores/holes. Such a spring plunger used for this purpose could be of a locking design which would allow it to be retracted and locked into the retracted position until required, simplifying the attachment and or rotation of the camera housing. In yet a further implementation, spring plungers may have a locking design such that upon release in a first position they engage groove 20 but cannot engage indexing bores/holes 27, and upon release in a second position they can extend into and engage indexing bores/holes 27. Accordingly, one or both of the spring plungers used to initially attach the turret mount top may also be used as an indexing pin.

It is understood, therefore, that a variety of spring plungers, retractable pins, and thumb screws may be implemented to provide for mechanical attachment as well as fast action, fast and secure positioning at predetermined angles (indexing), and single person operation.

It is noted that in a typical application, as represented in FIGS. 1-4, turret mount apparatus is mounted to the upper/top portion of hull 30; namely, assuming the scooter were beneath the water in a conventional orientation for diver propulsion, and with the hull axis oriented parallel to the surface of the water, the turret mount apparatus 10 would be facing the water surface with the turret axis of rotation 13 perpendicular to the water surface. The turret mount apparatus, however, may be mounted at any azimuthal angle about the hull cylindrical axis, even mounted to the lower/bottom portion of hull 30.

Additionally, even with the turret mount apparatus 10 mounted to the cylindrical surface of the hull, the turret axis is not limited to being perpendicular (or substantially perpendicular) to the hull axis and, more specifically, the plane in which the top surface of turret mount top 14 rotates is not limited to being parallel to (i.e., not intersecting) the hull axis (i.e., the plane is not required to include a line that is parallel to the hull axis). That is, turret mount base 12 and/or turret mount top 12 may be implemented to provide an angle or tilt so that, for example, the plane in which the turret mount top surface rotates intersects the hull axis. For instance, the turret mount base may have a nonuniform thickness/height (e.g., an angled or wedged shape), such as thicker/higher on the diver side and thinner on toward the front of the scooter (or vice versa, which may be achieved simply by reversing the orientation of the turret mount base). In an alternative implementation, a separate wedge or angled member may be first mounted to the hull, and the turret mount base mounted thereon. In such an implementation, the separate wedge or angled member surface onto which the turret mount base is mated may be shaped for attachment to a turret mount base that otherwise mounts to a hull (e.g., the wedge/angled member surface that mates with the turret base mount may have a cylindrical shape or a complementary modified V-groove shape, so that the same turret mount base that would be mounted to the hull may be mounted to the wedge/angled member). Alternatively, the turret mount base may be adapted to mate with the wedge/angled member (e.g., their mating surfaces may be planar).

Similarly, in yet another implementation, to achieve this height difference, one or more screwable leveling/tilting feet/pedestals may be provided on the underside, and towards one or both ends of, the turret mount base, these leveling/tilting feet advantageously adjustable from the top side of the turret mount base. Any feet/pedestals that would be positioned to contact the sloping portions of the hull may be angled, like the sloped V portions of the modified V-groove, to more securely engage and elevate the turret base mount.

It is also noted that in the foregoing the turret axis is defined with respect to the surface of the turret mount base 12. However, even if that turret axis is perpendicular to the hull axis, the upper surface of the turret mount top 14 may be angled/tilted so that it is not parallel to the upper surface of the turret mount base (e.g., the turret mount top may be wedge shaped).

In yet another implementation for angling the instrument, this can be accomplished by a split asymmetrical turret mount base, which can be rotated to create an angle. For instance, the turret mount base can include an upper portion (that includes the upper disc-like portion 12a) and a lower portion that contacts the hull, with these two portions capable of being affixed to each other in two positions such that the surfaces that mate to each other intersect the hull axis (e.g., the upper and lower portions are wedge shaped). In a first position, for example, with the two portions joined to each other at the sloped mating surfaces, the portions/slopes complement each other such that the top surface (instrument mounting surface) of the turret mount top is parallel to the hull axis. In a second position, achieved by rotating the upper portion 180 degrees relative to its orientation in the first position, with the two portions joined to each other at the sloped mating surfaces, the portions/slopes are additive such that the top surface (instrument mounting surface) of the turret mount top intersects the hull axis.

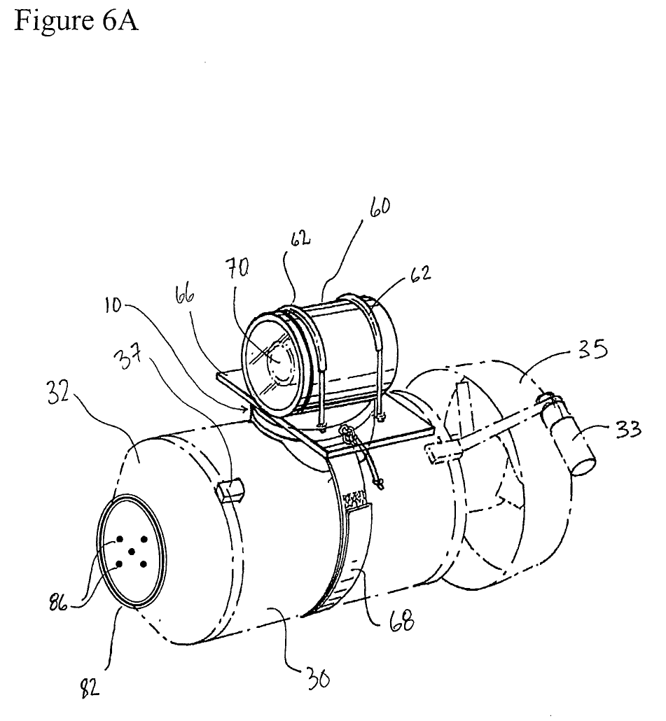

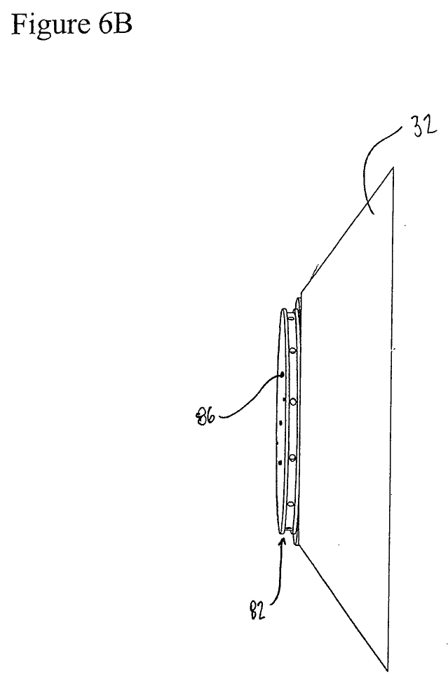

Referring now to FIG. 6A, there is shown a perspective view of a DPV comprising a propeller portion 35, a handle/arm 33, and cylindrical hull 30, which includes a nose portion 32 latched (e.g., latch 37) thereto.

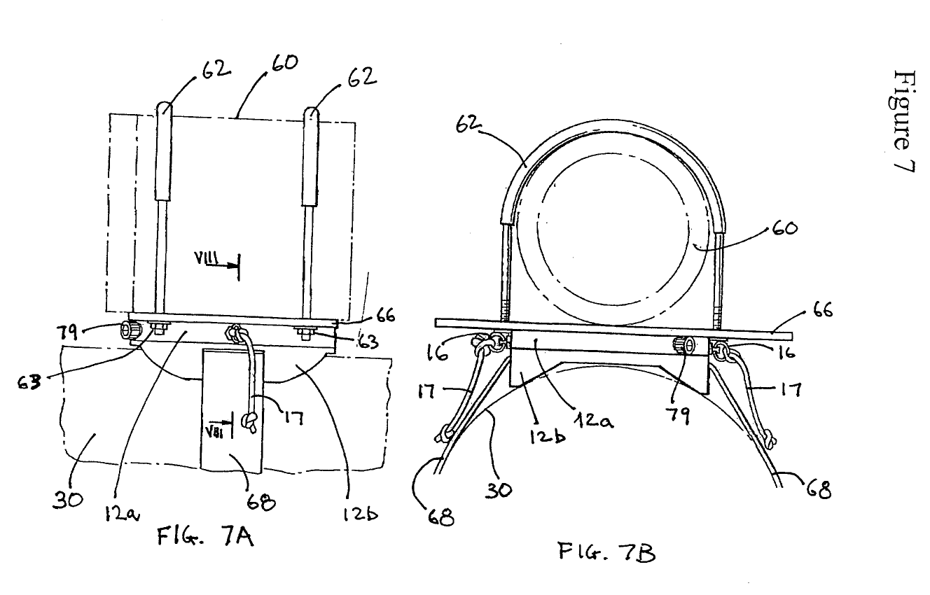

FIG. 6A illustrates the use of an adaptor plate 66 for attaching an instrument housing to turret mount apparatus 10. More specifically, in this application, turret mount apparatus 10 is attached to hull 30 by a cam strap 68, and is coupled by means of adaptor plate 66 to a sealable housing 60 that contains a video camera 70. As noted above, instrument housings (e.g., camera housings) may have myriad designs at their base for the attachment of lights, etc. to the housing. As there are so many designs, it is unrealistic that a single turret mount top 14 will have a standard way to attach to a variety of such designs. As also noted above, however, in accordance with an embodiment of the present invention, the turret mount top may include a top plate portion that may be customized for attachment to a given instrument. In some instances, however, a separate adapter plate may nevertheless be needed or desirable. For instance, the size (e.g., diameter) and shape (cylindrical) of sealable housing 60 are well suited for using an adaptor plate 66 that is distinct from the turret mount top plate. This embodiment, therefore, illustrates that where an instrument housing is not attached directly to the turret mount top 14, the use of a thin adapter plate will allow customization for each application. As will be understood from the additional views corresponding to FIG. 6A that are presented in FIGS. 7A, 7B, 8-10, 11A, 11B, 12, and 13, adapter plate 66 is affixed to turret mount top 14 and also has mounting features customized to the sealable housing 60 that is mounted thereto using U-shaped clamps 62. It is further noted, however, that while this illustrated embodiment shows a sealable chamber to house a camera secured to the camera adapter plate which is in turn mountable on the mounting disc, in other embodiments, cameras suitable for underwater use may be mounted directly to the camera mounting disc or adapter plate.

FIG. 7A and FIG. 7B illustrate a side view and a front view, respectively, of sealable chamber 60 mounted to adaptor plate 66 via U-clamps 66 that pass through bores in adaptor plate 66 and are affixed thereto by nuts 63. In this embodiment, thumb screws 79 are used instead of retractable pins 18. To facilitate grasping and manipulation of stainless steel spring plungers 16, each plunger has a rope 17 attached thereto.

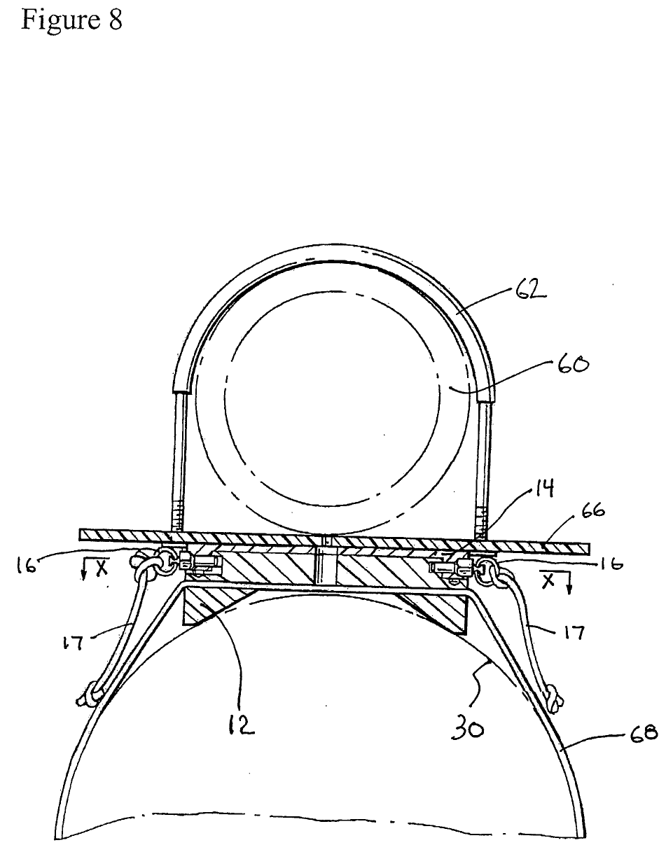

FIG. 8 depicts a cross-section taken from the vantage point identified by reference label VIII in FIG. 7A. The engagement of groove 20 in turret mount base 12 by spring plungers 16 may be seen. A center bore in turret mount top 14 aligned with a center bore in adapter plate 66 is used for attaching, e.g., by way of a bolt/screw, adapter plate 66 to turret mount top 14.

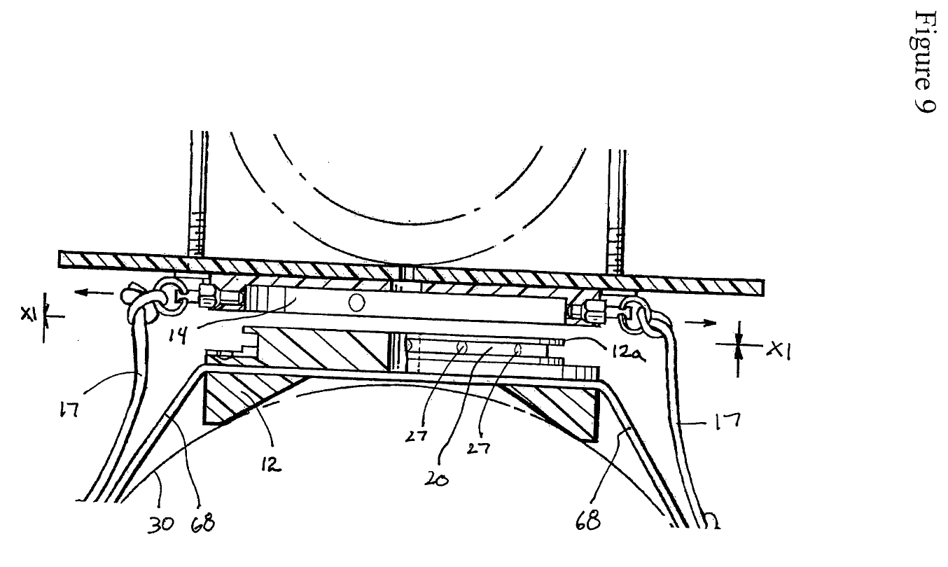

FIG. 9 illustrates a cross-section corresponding to the cross-section of FIG. 8, but with turret mount top 14 spaced away from (elevated above) turret mount base 12. Also in this view, a portion of the upper disc-like portion 12a of turret mount base 12 is depicted from a view to show groove 20 and index bores/holes 27.

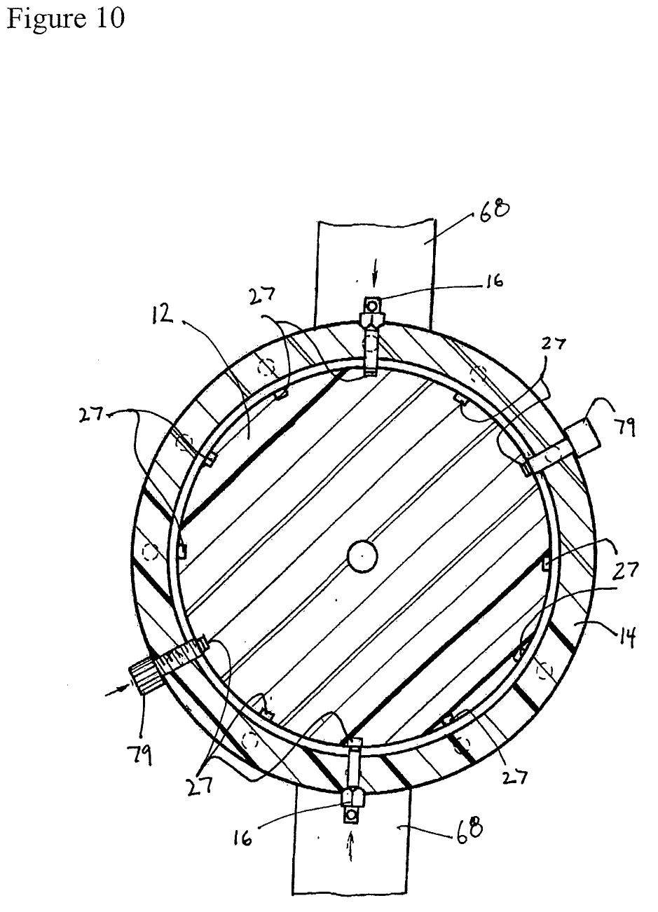

FIG. 10 depicts a cross-section taken from the vantage point identified by reference label X in FIG. 8. The engagement of index bores/holes 27 by both thumb screws 79 and one of the spring plungers 16, and the positioning of the other spring plunger 16 in groove 20, may be seen.

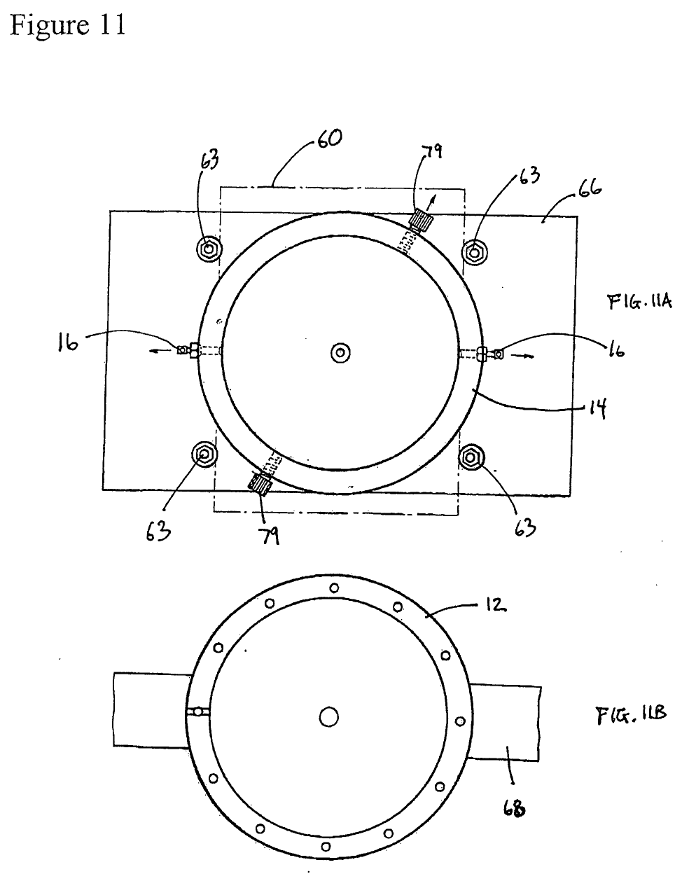

FIG. 11A depicts a bottom view, looking up from the vantage point identified by reference label XI in FIG. 10. As noted above, a center bore in turret mount top 14 aligned with a center bore in adapter plate 66 is used for attaching, e.g., by way of a bolt/screw, adapter plate 66 to turret mount top 14. FIG. 11B depicts a top view, looking down from the vantage point identified by reference label XI in FIG. 10, thus showing turret mount base 12 and cam strap 68.

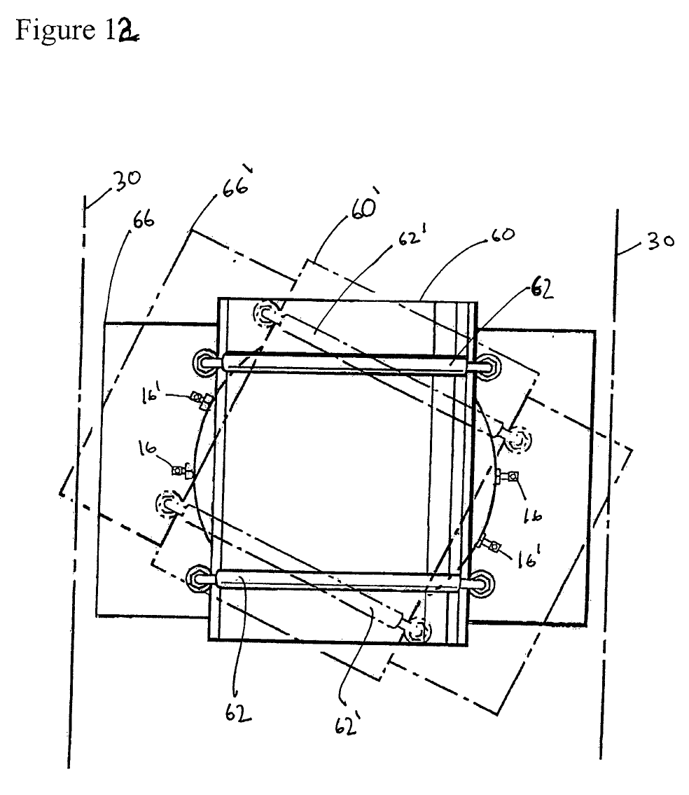

FIG. 12 illustrates a top view, looking down onto hull 30, adaptor plate 66, and sealable housing 60, for two different azimuthal angles of the turret mount apparatus. In a first orientation, solid lines are used to depict adaptor plate 66, and sealable housing 60, and U-clamps 62, and all reference numerals are unprimed. In a second orientation, dashed lines re used to depict these components, and reference numerals are primed, namely, the same components adaptor plate 66, and sealable housing 60, and U-clamps 62 are represented by reference numerals, 66′, 60′, and 62′, and similarly, spring plungers 16 are referenced as 16′.

Referring again to FIG. 6A, in accordance with a further embodiment of the present invention, a turret mount base 82 is shown affixed to the forward end of nose portion 32 such that an instrument attached to a complementary turret mount top (not shown) that is mounted onto turret mount base 82 may be oriented and rotated in a plane that is substantially perpendicular to hull axis, allowing, for instance, for a camera to be oriented downward as a diver is propelled forward at a constant depth. In this embodiment, the turret axis of turret mount base 82 is coaxial with the hull axis. FIG. 6B shows a closer view of nose portion 32 with turret mount base 82 mounted thereto. Turret mount base 82 has a construction essentially the same as turret mount base 12, except that the lower base portion is not adapted to mate with a cylindrical surface (e.g., it does not have a modified V-groove), but rather is shaped and configured to mate with the forward end of nose portion 32 (not visible), which is a substantially planar surface that is perpendicular to the hull axis. Accordingly, in this implementation, lower base portion (not visible) is substantially planar. Additionally, in this embodiment, five through holes are disposed in the turret axis direction of turret base 82 so that bolts/screws 86 may be used to fixably mount base 82 to nose portion 32. It is understood that this embodiment also allows for two instruments to be simultaneously rotatably mounted to the DPV, one being mounted to base 82, the other being mounted to a turret mount apparatus 10 that is attached to the cylindrical portion of hull 30. If both instruments are cameras, then two videos from different views may be taken simultaneously. Alternatively, one instrument may be a light and the other a camera, with the instruments respectively oriented such that the light provides illumination for the video while mitigating backscattering.

In accordance with the foregoing description of illustrative embodiments of the present invention, and illustrative variations or modifications thereof, it may be appreciated that the present invention provides many features, advantages and attendant advantages, including the following illustrative features and advantages, all or any one or more of which are not necessarily provided by practicing the invention, and all or any one or more of which are not intended to limit the scope of the present invention. In accordance with a feature of various embodiments of the present invention, portable, handheld equipment or instruments can be removably and rotatably mounted to a vehicle platform. When the equipment is mounted on the platform, the equipment can be rotated about the axis of the mount, and preset positions may be provided to securely maintain equipment orientation.

Systems made according to various embodiments of the present invention allow attachment of myriad instruments (sonar, still camera, video camera, tracking device, lights, laser guide, etc.) to a vehicle platform via a turret mounting system. Advantages of embodiments of the present invention include: the stability provided by a turret mount; the possibility to steadily rotate the instrument (e.g., panning) 360 degrees about the turret rotation axis; the fast and easy mounting/removal of the instrument from the turret, which can be performed by a single individual without tools; the ability to set and lock the rotation to present angles; the low profile (e.g., the turret housing may be made such that it sits only about one inch from the hull); the ease of attachment and detachment of mounted instruments; and secure positional selectability of the mounted instrument. Consonant with these and other advantages, design considerations comprehensively addressed by embodiments of the present invention include:
1. Stability of the turret mount base to scooter. The turret mount base should be securely attached to the scooter so that there is no movement when the scooter is moving through the water. Most underwater scooters/DPV's have cylindrical hulls so attaching a camera is not as simple as if it were to a flat surface.
2. Stability of the turret mount top to the turret mount base. As the instrument (e.g., camera) affixed to the turret mount top (as explained in detail below) will be able to rotate 360 degrees, there is a difficulty to ensure there is no slack or play between the two aforementioned mated parts, particularly during rotation of the turret mount top relative to the turret mount base. This is made more difficult being underwater, as tight tolerances on unsealed rotating parts often get clogged with sand which is in the water, stirred up by wave action, divers or scooters.
3. Low profile. The instrument (e.g., camera) should ideally be mounted as close as possible to the scooter to minimize drag. Achieving this feature or design goal is challenging when designing embodiments of the present invention because such embodiments include a mechanism between the instrument (e.g., camera) and the scooter hull to allow rotation of the instrument.
4. Ease of attachment. It is a very simple task to attach and detach an instrument (e.g., camera) to the scooter, without tools, as it is often necessary or desirable to do this at the water's surface. For example, for boat diving in rough seas, it is much better to lower the scooter and the camera into the water separately and then attach in the water, to minimize risk of equipment damage. Also, it is sometimes desirable to take the camera off the scooter while in the middle of a shoot, to take a shot which would be difficult if the camera were not removably attached to the scooter.
5. Securing the camera at an angle. There is a lot of drag in the water. Some camera housings are quite large, and there will be a lot of force acting against the rotating parts. This makes it more difficult to design a mounting system which is strong enough to hold the camera at an angle without slipping, while also using a minimum of parts, and which is very easy and fast to adjust.

The present invention has been illustrated and described with respect to specific embodiments thereof, which embodiments are merely illustrative of the principles of the invention and are not intended to be exclusive or otherwise limiting embodiments. For instance, although the description provided hereinabove along with the accompanying drawings illustrate the male part of the turret attached to the scooter, and the female part of the turret as part of the rotating turret mount top, those skilled in the art will understand in view of the hereinabove disclosure that a complementary configuration can be implemented, as well as other designs capable of achieving the purpose of these components. As a further illustrative example, although the hereinabove embodiments have been described with respect to an underwater scooter, a turret mount apparatus according to the present invention may be implemented for mounting instruments to other vehicle platforms, such as for mounting a video camera mounted to a motorcycle fuel tank.

As yet another non-limiting example, although the rotating turret mount top in the hereinbove illustrative embodiment is capable of rotating a full 360 degrees (and continuously through 360 degrees), alternative embodiments of the present invention may provide a restricted range of rotation (e.g., up to but not though 360 degrees, or up to 270 degrees, or up to 180 degrees, etc.) of the rotating turret mount top. As a further example, while spring plungers (e.g., spring loaded detent pins 16) are described as mechanisms for selectively engaging the turret mount top and turret mount base, other fastening/engagement mechanisms, even ones that may not be retractable may be used. For instance, the turret mount top may have a fixed (e.g., integrally formed) tab disposed radially inward from a portion of its inner cylindrical surface, and the turret mount base may have a radial slot at the top of its periphery/circumference such that in lowering the turret mount top onto the turret mount base, the tab may pass down into the slot to be positioned in the groove region such that the tab moves within and along the groove region as the turret mount top is rotated.

As still another illustrative example, although rotation of the rotating turret mount top in the hereinbove illustrative embodiments is provided by the coupling between the turret mount top and the turret mount base, in alternative implementations the rotating coupling/mechanism may be embodied entirely within either the rotating turret mount top (i.e., to which the instrument is attachable) or the turret mount base (or possibly in both the turret mount top and the turret mount base), with the coupling between the turret mount base and turret mount top establishing a fixed spatial relationship between the portions of the turret mount base and turret mount top that are directly attached/affixed by the coupling.

Accordingly, although the above description of illustrative embodiments of the present invention, as well as various illustrative modifications and features thereof, provides many specificities, these enabling details should not be construed as limiting the scope of the invention, and it will be readily understood by those persons skilled in the art that the present invention is susceptible to many modifications, adaptations, variations, omissions, additions, and equivalent implementations without departing from this scope and without diminishing its attendant advantages. It is further noted that the terms and expressions have been used as terms of description and not terms of limitation. There is no intention to use the terms or expressions to exclude any equivalents of features shown and described or portions thereof. It is therefore intended that the present invention is not limited to the disclosed embodiments but should be defined in accordance with the claims that follow.

I claim:

1. An apparatus comprising:
a base mount configured to be fixed relative to a vehicle platform;
an instrument mount that is attachable to an instrument, and that is configured to removably mount onto said base mount, the instrument mount capable of being rotated about an axis of rotation when mounted to said base mount; and
at least one fastening mechanism that provides selective engagement of the instrument mount and the base mount.

2. The apparatus according to claim 1, wherein the instrument mount and the base mount are configured to provide a direct coupling therebetween for mounting the instrument mount to the base mount, and wherein the rotation of the instrument mount is provided by the direct coupling of the instrument mount and the base mount when the instrument mount is removably mounted to the base mount.

3. The apparatus according to claim 2, wherein the direct coupling is provided between (i) a disc-shaped plate having a cylindrical outer sidewall surface that has a circumferential groove; and (ii) a mating structure having a cylindrical inner sidewall surface that is disposed near, and coaxial with, said. cylindrical outer sidewall surface when said instrument mount is removably mounted to the base mount, said mating structure further comprising at least one through-bore that traverses said cylindrical inner sidewall surface and in which is provided at least one respective fastener that is movable to selectively engage said circumferential groove.

4. The apparatus according to claim 3, wherein the base mount comprises said disc-shaped plate, and said instrument mount comprises said mating structure.

5. The apparatus according to claim 3, wherein said vehicle platform is an underwater scooter.

6. The apparatus according to claim 3, wherein said disc-shaped plate includes at least one bore formed into the sidewall of the groove, said bore being selectively engageable by a fastening member disposed through the inner sidewall surface of said structure.

7. The apparatus according to claim 6, wherein the fastening member includes at least one of said at least one respective fastener.

8. The apparatus according to claim 3, wherein two of said at least one respective fastener are provided as spring loaded detent pins that are disposed at substantially 180 degrees apart azimuthally about the axis of rotation.

9. The apparatus according to claim 8, wherein at least another of said at least one respective fasteners is provided as a retractable pin or a thumb screw.

10. The apparatus according to claim 3, wherein said instrument mount is continuously rotatable through 360 degrees.

11. The apparatus according to claim 2, wherein the direct coupling includes a means for indexing the rotational position of the instrument mount.

12. The apparatus according to claim 2, wherein the base mount is removably mountable to the vehicle platform.

13. The apparatus according to claim 13, wherein the vehicle platform is an underwater scooter, and said base mount includes a slot operative in mounting the base mount to the underwater scooter means of a cam strap.

14. The apparatus according to claim 2, wherein the base mount is integral with the vehicle platform, such that the base mount is not detachable from the vehicle platform.

15. The apparatus according to claim 14, wherein the base mount is welded to, or integrally formed with, the vehicle platform.

16. The apparatus according to claim 2, wherein the base mount includes a modified V-groove for mounting the base mount to the vehicle platform.

17. The apparatus according to claim 2, wherein the instrument mount is capable of being attached to, and detached from, the base mount by a single individual by hand without the use of tools.

18. The apparatus according to claim 2, wherein the instrument mount is directly attachable to the instrument.

19. The apparatus according to claim 2, wherein the instrument mount is attachable to an adapter plate that is configured to attach to the instrument, the instrument mount thereby being indirectly attachable to the instrument by means of the adapter plate.

20. An underwater scooter comprising a turret mount base that is configured to engage with a turret mount top such that the turret mount top is rotatable.

21. The underwater scooter according to claim 20, wherein the turret mount base is integrally formed with, or welded to, the underwater scooter.

22. An apparatus comprising:
base means for mounting to an underwater scooter; and
top means for removably mounting to said base means and for mounting to an instrument, said top means being rotatable about an axis of rotation when mounted to said base mount; and
means for selectively engaging the top means and the base means.

23. The apparatus according to claim 23, further comprising means for indexing the rotational position of the top means.

24. A method for attaching an instrument to an underwater scooter, the method comprising:
providing a turret securable to the underwater scooter; and
attaching the instrument to the turret.

25. The method according to claim 24, wherein the turret is detachable from the underwater scooter.

26. The method according to claim 24, wherein at least a portion of the turret is integrally formed with, or welded to, the underwater scooter.

27. The method according to claim 24, wherein the turret comprises a turret mount that attaches to the underwater scooter, and an instrument mount that is removably attachable to the turret mount and is attachable to the instrument.

28. The apparatus according to claim 4, wherein the instrument mount comprises a top plate that is removably attached to said mating structure, said top plate being configured for attachment to said instrument, said mating structure being in the shape of a collar.

29. The apparatus according to claim 4, wherein the instrument mount comprises a top plate portion integral with said mating structure, said top plate portion being configured for attachment to said instrument.

30. A turret mount apparatus, comprising: a turret mount base that is removably attachable to an underwater scooter; and a turret mount top that is configured to engage with said turret mount base such that the turret mount top is rotatable, said turret mount top being attachable to an instrument.
